(19) United States
(12) Patent Application Publication
(10) Pub. No.: US 2010/0035133 A1
(43) Pub. Date: Feb. 11, 2010

(54) ELECTRONIC DEVICE

(75) Inventor: WEI-JUN WANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Taipei Hsien (TW)

(21) Appl. No.: 12/339,325

(22) Filed: Dec. 19, 2008

(30) Foreign Application Priority Data
Aug. 5, 2008 (CN) 200810303378.3

(51) Int. Cl. H01M 2/10

(52) U.S. Cl. 429/100

(57) ABSTRACT

An electronic device includes a main body, a battery, and a fixing assembly. The main body defines a receiving cavity. Opposite sidewalls of the main body in the receiving cavity defines two latching slots. The battery forms two latching protrusions on opposite sides of the battery. The latching protrusions are configured to engage in the two latching slots. The fixing assembly includes a locking member and an elastic member. The locking member is driven by the elastic member to fix the battery in the receiving cavity.

### BACKGROUND

1. Technical Field

The present disclosure relates to an electronic device and, more particularly, to an electronic device with a battery securing mechanism.

2. Description of the Related Art

Electronic devices, such as mobile phones, notebook computers, and personal digital assistants, are widely used in recent years. These electronic devices are generally configured to have rechargeable batteries.

A typical electronic device includes a main body and an elastic member. The main body defines a rectangular space for receiving a battery. The elastic member has two hooks on its two ends. Two openings are defined in opposite sidewalls adjoining the rectangular space. The hooks are inserted into the two openings to engage with inner walls of each opening.

In use, the battery is placed into the space. One hook of the elastic member is inserted into one opening of the main body. Then, the elastic member is extended over a top of the battery, and the other hook is inserted into the other opening of the main body to engage the inner walls of the opening, thus securing the battery to the space.

However, the hooks easily detach from the openings, resulting in a poor mechanical reliability.

Therefore, a new electronic device is desired to overcome the above-described shortcomings.

### SUMMARY

An electronic device includes an main body, a battery, and a fixing assembly. The main body defines a receiving cavity. Opposite sidewalls of the main body in the receiving cavity defines two latching slots. The battery forms two latching protrusions on opposite sides of the battery. The latching protrusions are configured to engage in the two latching slots. The fixing assembly includes a locking member and an elastic member. The locking member is driven by the elastic member to fix the battery in the receiving cavity.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present electronic device. Moreover, in the drawings, like reference numerals designate corresponding parts throughout several views, and all the views are schematic.

FIG. 1 is an isometric view of a first embodiment of an electronic device, the electronic device including a main body, a battery, and a fixing assembly.

FIG. 2 is an enlarged view of a circled portion II of the electronic device in FIG. 1.

FIG. 3 is an enlarged view of a circled portion III of the electronic device in FIG. 1.

FIG. 4 is an exploded isometric view of the electronic device in FIG. 1.

FIG. 5 is an enlarged view of a circled portion V of the electronic device in FIG. 4.

FIG. 6 is an enlarged view of a circled portion VI of the electronic device in FIG. 4.

FIG. 7 is an isometric view of the fixing assembly of the electronic device in FIG. 1.

FIG. 8 is an enlarged view of a portion of the electronic device in FIG. 1, but shown from another aspect.

FIG. 9 is an enlarged view of a portion of a second embodiment of an electronic device.

### DETAILED DESCRIPTION OF THE EMBODIMENTS

Reference will now be made to the drawings to describe embodiments in detail.

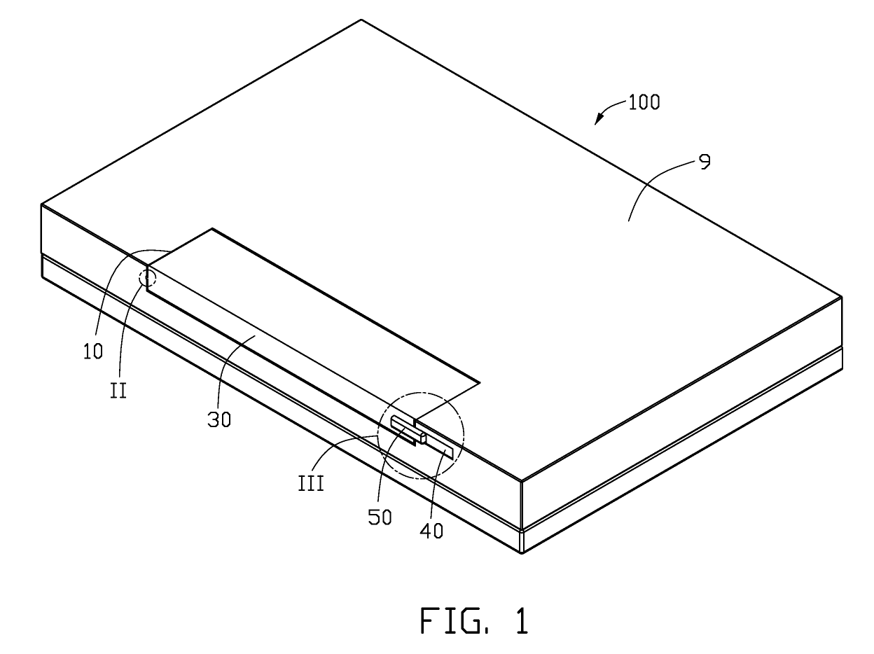

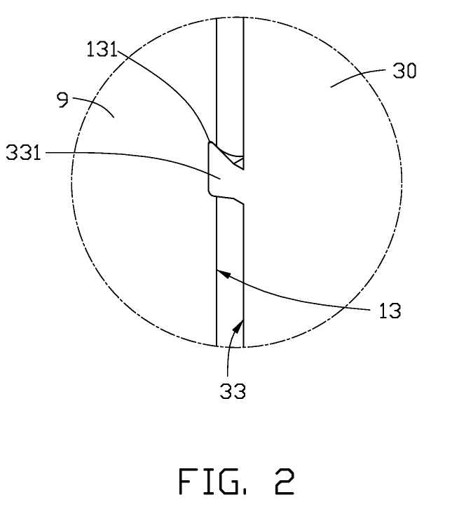

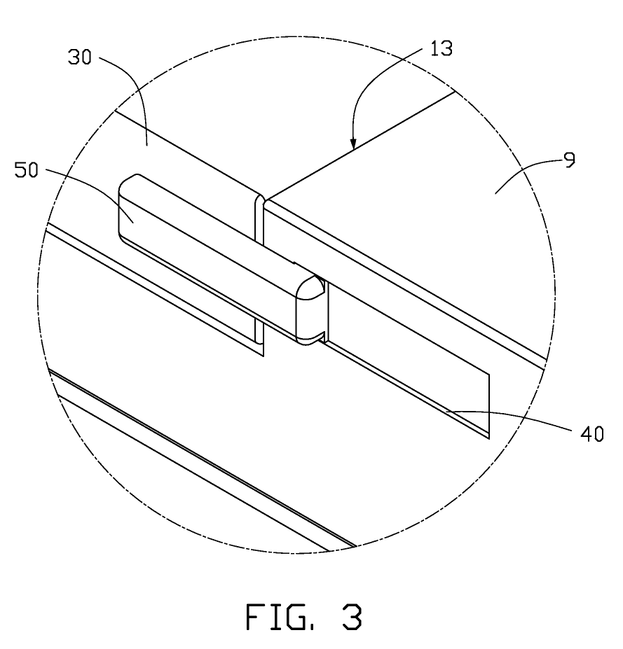

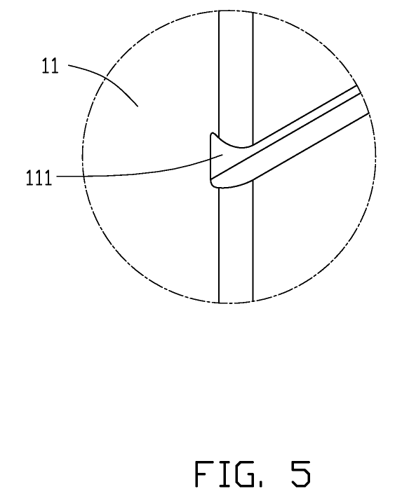

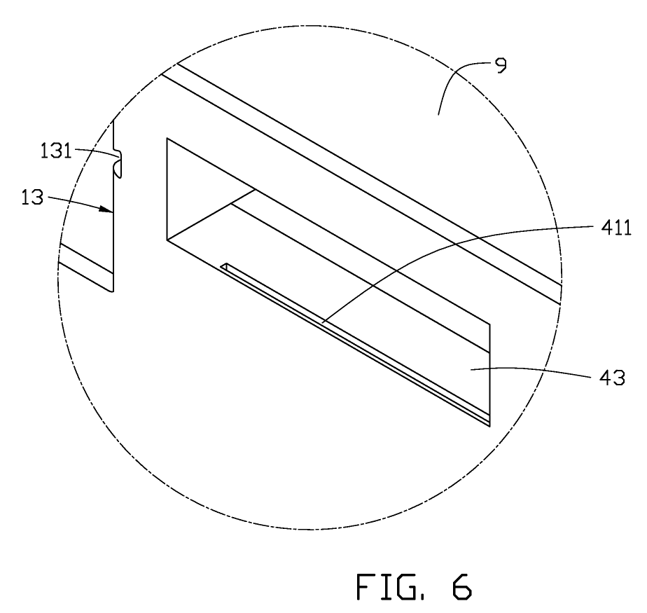

Referring to FIGS. 1 through 6, an electronic device 100 includes a main body 9, a battery 30, and a fixing assembly 50. The main body 9 defines a receiving cavity 10 and a receiving groove 40 adjacent to the receiving cavity 10. The battery 30 is positioned in the receiving cavity 10. The fixing assembly 50 is partially positioned in the receiving cavity 40 to fix the battery 30 in the receiving cavity 10.

The receiving cavity 10 is cooperatively defined by a first side wall 11, a second side wall 13 parallel to the first sidewall 11, and a third side wall 15 connecting the first side wall 11 and the second side wall 13. The first side wall 11 defines a first latching slot 111 and the second side wall 13 defines a second latching slot 131. A shape of the first latching slot 111 and the second latching slot 131 may have any shape, such as rectangular, trapezoidal, and triangular. In the illustrated embodiment, the first latching slot 111 and the second latching slot 131 are female dovetail grooves.

A shape of the battery 30 corresponds to the shape of the receiving cavity 10. The battery 30 includes a first side surface 31, a second side surface 33 opposite the first side surface 31, and a third side surface 35 connecting the first side surface 31 and the second side surface 33. The first side surface 31 forms a first latching protrusion 311 configured to engage with the first latching slot 111 and the second side surface 33 forms a second latching protrusion 331 configured to engage with the second latching slot 131. In the illustrated embodiment the first latching protrusion 311 and the second latching protrusion 331 are male dovetail grooves. The third side surface 35 is exposed out of the main body 9.

The receiving groove 40 is configured to receive the fixing assembly 50. The receiving groove 40 includes an inner sidewall 41. The inner sidewall 41 defines an opening 43 and a sliding slot 411 adjacent to the opening 43. An extending direction of the sliding slot 411 is parallel to a direction of the receiving groove 40.

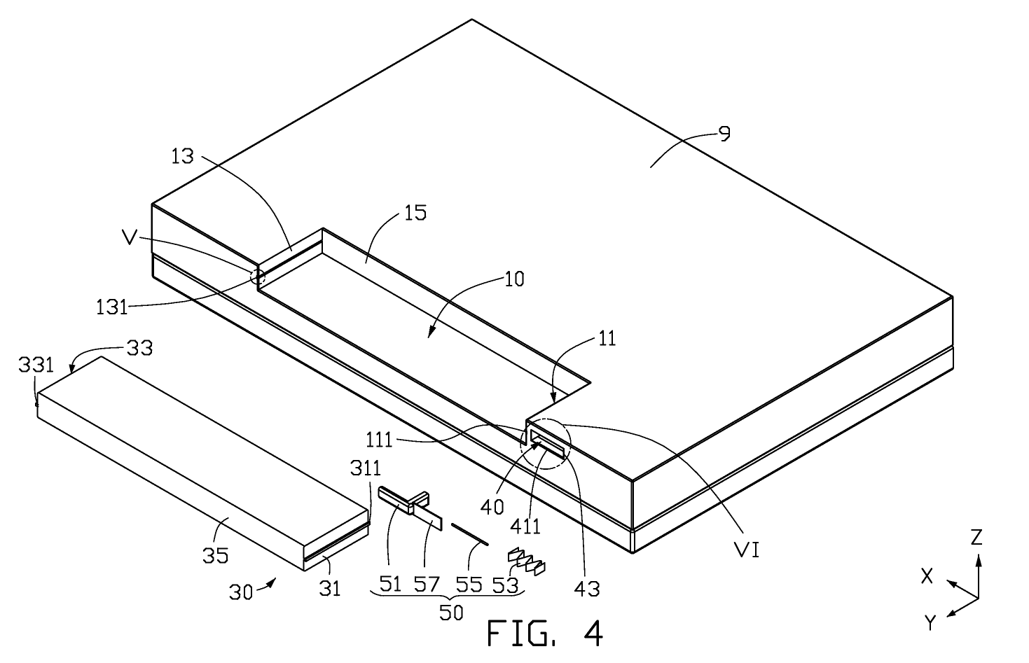

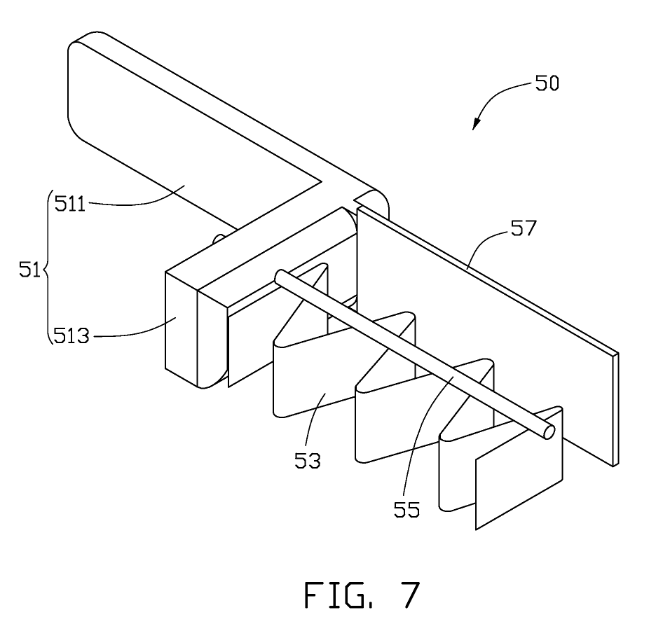

Referring to FIGS. 4 and 7, the fixing assembly 50 includes a locking member 51, an elastic member 53 connected to the locking member 51, a guiding member 55 passing through the locking member 51, and a limiting plate 57 connected to the locking member 51.

The locking member 51 includes a button 511 and a resisting member 513 extending from an end of the button 511. The button 511 is exposed out of the main body 9. The resisting member 513 connects with the button 511 to form an L-shaped configuration. The resisting member 513 is positioned in the receiving groove 40 and the button 511 is exposed out of the main body 9.

A first end of the elastic member 53 abuts against the resisting member 513 and a second end of the elastic member 53 abuts against the inner sidewall 41 of the receiving groove 40. When the button 511 resists the battery 30, the elastic member 53 is in a free status. The elastic member 53 may be an elastic element such as a helical spring, leaf spring, and a rubber element. In the illustrated embodiment, the elastic member 53 is a leaf spring, thereby increasing a contact area between the elastic member 53, the resisting member 513, and the inner sidewall 41 of the receiving groove 40.

The guiding member 55 is substantially parallel to the extending direction of the sliding slot 411. In the illustrated embodiment, the guiding member 55 is cylindrical. Opposite ends of the guiding member 55 are fixed in the receiving groove 40. The resisting member 513 of the locking member 51 is slidable along the guiding member 55.

When the button 511 slides along the receiving groove 40, the limiting plate 57 slides in the sliding slot 411. In addition, the receiving groove 40 is hidden from view outside the main body 9 by the limiting plate 57. The limiting plate 57 also prevents dusts entering the receiving groove 40.

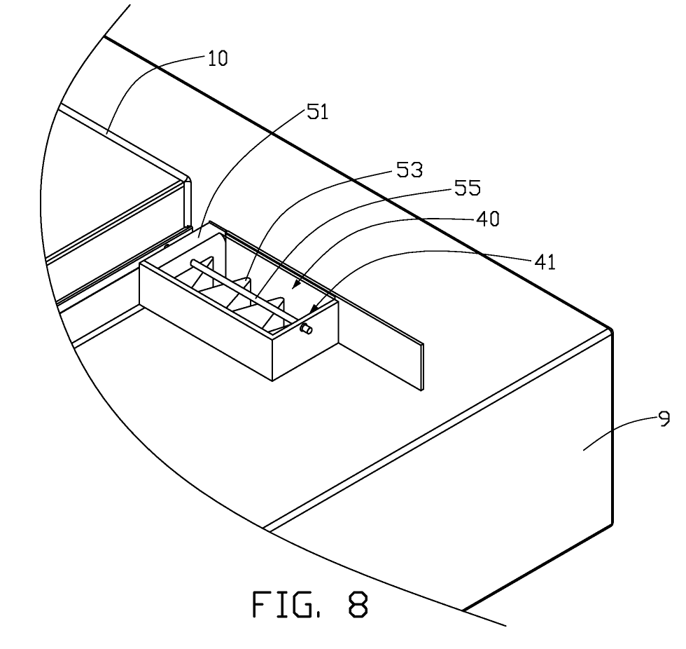

Referring to FIGS. 1 and 8, the battery 30 is slid in the main body 9, by pushing the button 511 to slide towards a direction away from the receiving cavity 10, thereby compressing the elastic member 53. The first latching protrusion 311 and the second latching protrusion 331 engage in the first latching slot 111 and the second latching slot 131 respectively, thereby confining the battery 30 to slide into the receiving cavity 10. The first side wall 11 and the second side wall 13 also guide the battery 30 along. While the battery 30 is pushed into the receiving cavity 10, the button 511 is unable to move toward the receiving cavity 10.

When the battery 30 is completely received in the receiving cavity 10, the button 511 is urged by the elastic member 53 to move towards the receiving cavity 10 along the guiding member 55. The button 511 resists the third side surface 35 of the battery 30. The button 511 and the third side wall 15 of the receiving cavity 10 prevent the battery 30 from moving, thereby removably fixing the battery 30 to the receiving cavity 10.

To detach the battery 30 from the main body 9, the button 511 is pulled to move along a direction away from the receiving cavity 10, so that the third side surface 35 is no longer blocked by the button 511. The battery 30 may now be removed from the receiving cavity 10 by sliding the battery 30 out along the first and second latching slots 111, 131.

The battery 30 is held in place by the first and second latching slot 111, 131, and the first and second side walls 11, 13 of the receiving cavity 10, so there is no need for additional fixing structures. Thus, a configuration of the electronic device 100 is simplified. The third side wall 15 of the receiving cavity 10 and the fixing assembly 50 further fixes the battery 30 to the receiving cavity 10.

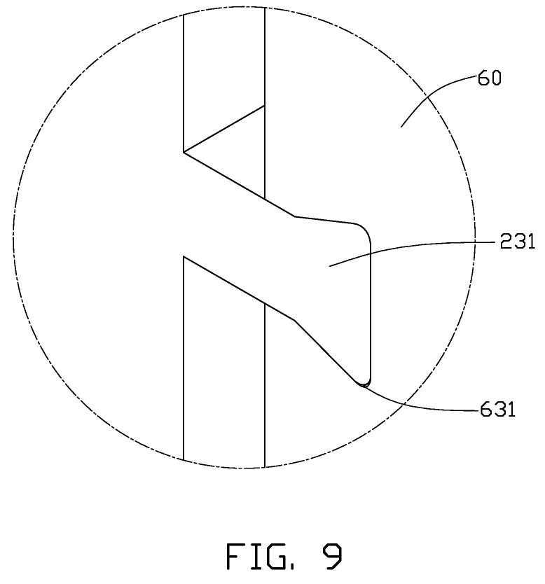

Referring to FIG. 9, a second embodiment of an electronic device (not labeled) is similar to the first embodiment of the electronic device 100 of FIG. 1, except that the second latching slot 131 may be replaced by a second latching protrusion 231, and the second latching protrusion 331 of the battery 30 may be replaced by a latching slot 631 of a battery 60.

While various embodiments have been described and illustrated, the embodiments are not to be construed as being limited thereto. Various modifications can be made to the embodiments by those skilled in the art without departing from the true spirit and scope of the invention as defined by the appended claims.

What is claimed is:

1. An electronic device, comprising:
a main body defining a receiving cavity, wherein two latching slots are defined in opposite sidewalls of the receiving cavity;
a battery comprising two latching protrusions on opposite sides of the battery, the latching protrusions being configured to engage in the two latching slots; and
a fixing assembly comprising an elastic member and a locking member driven by the elastic member to fix the battery in the receiving cavity.

2. The electronic device as claimed in claim 1, wherein a receiving groove adjacent to the receiving cavity is defined in the main body; the fixing assembly further comprises a guiding member passing through the locking member and fixed in the receiving cavity; the locking member is slidable along the guiding member.

3. The electronic device as claimed in claim 1, wherein the locking member comprises a button exposed out of the main body and a resisting member connected to the button and positioned in the receiving groove.

4. The electronic device as claimed in claim 3, wherein a sliding slot is defined in the receiving cavity; the locking member further comprises a limiting plate slidably received in the sliding slot.

5. The electronic device as claimed in claim 4, wherein a first end of the elastic member is contacting the resisting member and a second end of the elastic member is contacting an inner wall of the receiving groove.

6. The electronic device as claimed in claim 5, wherein the elastic member is a spring.

7. The electronic device as claimed in claim 4, wherein the button and the resisting member are connected and form an L-shaped configuration.

8. An electronic device, comprising:
a main body defining a receiving cavity therein, wherein the receiving cavity forms two latching protrusions on opposite sidewalls;
a battery, wherein two latching slots are defined in opposite sides of the battery, and configured to engage with the two latching slots; and
a fixing assembly comprising an elastic member and a locking member driven by the elastic member to fix the battery in the receiving cavity.

9. The electronic device as claimed in claim 8, wherein a receiving groove adjacent to the receiving cavity is defined in the main body; the fixing assembly further comprises a guiding member passing through the locking member and fixed in the receiving groove; the locking member is slidable along the guiding member.

10. The electronic device as claimed in claim 8, wherein the locking member comprises a button exposed out of the main body and a resisting member connected to the button and positioned in the receiving groove.

11. The electronic device as claimed in claim 10, wherein a sliding slot is defined in the receiving cavity; the locking member further comprises a limiting plate slidably received in the sliding slot.

12. The electronic device as claimed in claim 11, wherein a first end of the elastic member is contacting the resisting member and a second end of the elastic member is contacting an inner wall of the receiving groove.

13. The electronic device as claimed in claim 12, wherein the elastic member is a spring.

14. The electronic device as claimed in claim 11, wherein the button and the resisting member are connected and form an L-shaped configuration.
